(19) United States
(12) Patent Application Publication
(10) Pub. No.: US 2026/0340219 A1
(43) Pub. Date: Oct. 29, 2026

(54) Coordinate Based Planning Precision Construction Method

(71) Applicant: Daniel Dunlop, Tulsa, OK (US)

(72) Inventor: Daniel Dunlop, Tulsa, OK (US)

(21) Appl. No.: 19/190,169

(22) Filed: Apr. 25, 2025

(51) Int. Cl. G06F 30/18; G06F 113/14; G06Q 50/08

(52) U.S. Cl. CPC G06F 30/18; G06Q 50/08; G06F 2113/14

(57) ABSTRACT

A coordinate-based plumbing installation system and method are disclosed for improving the precision, efficiency, and documentation of plumbing system installations in construction environments. The method includes generating a three-dimensional coordinate framework based on construction site blueprints, assigning coordinate data to key plumbing layout locations, and producing a coordinate-enhanced blueprint. This blueprint is transmitted to digital field devices that guide installers using visual or haptic feedback systems, such as augmented reality or laser marking tools, to position components accurately. The system also includes modules for CAD-based coordinate extraction, real-time annotation and revision, automated material estimation, and post-installation verification using defined tolerance thresholds. Data generated throughout the process is stored in a searchable database to support future maintenance, inspection, or upgrades. The system supports integration with BIM platforms and enables interactive collaboration across project phases, reducing errors, material waste, and labor inefficiencies.

### PRIORITY BENEFIT CLAIM

This application claims priority to prior filed Provisional Patent Application No. 63/565,906 filed on Mar. 15, 2024.

### BACKGROUND

### Field of Use

This invention addresses inaccuracies in traditional plumbing construction, leading to material wastage and inefficiencies in construction timelines. This invention introduces a ground breaking approach to drafting, planning, and executing plumbing systems for construction projects. It employs a meticulously developed coordinate system integrated with blue prints, allowing for precise real world application. This method facilitates a more efficient, accurate, and waste-minimizing process for builders and contractors.

At the core of this invention is a unique drafting technique that incorporates a detailed coordinate system into plumbing blueprints. This system assigns specific coordinates to key points within the plumbing layout, such as angle changes, branch beginnings, and points where pipes rise through the foundation. These coordinates are directly translatable to the physical space of the construction site, ensuring unparalleled precision in the installation process.

### Background of Prior Art

The present invention presents a novel approach to plumbing system design and execution by integrating a precise coordinate system with construction blueprints, fundamentally enhancing the accuracy, efficiency, and sustainability of construction projects.

In contemporary commercial and residential construction projects, meticulous planning precedes the installation of plumbing systems. This planning phase is marked by a rigorous adherence to local building codes and regulations, ensuring that every aspect of the plumbing design complies with legal standards. Plumbing engineers or designers meticulously craft detailed plans that encompass the layout, pipe sizing, fixture placement, and connection points. They calculate water demand, design water distribution systems for optimal pressure and flow, and plan drainage systems to efficiently remove wastewater while preventing clogs and odors.

During the installation phase, skilled professionals execute the meticulously designed plans with precision. Pipes, typically constructed of materials such as copper, PVC, PEX, or CPVC, are installed according to the layout specifications, secured firmly, and rigorously tested for leaks. Fixtures, carefully selected based on usage, efficiency, and aesthetics, are installed following manufacturer guidelines and local codes to ensure proper sealing and connection to the plumbing system. Vent pipes are strategically placed to release sewer gases and maintain proper pressure, often extending through the roof of the building. Additionally, backflow prevention devices are installed to safeguard the main water supply from contamination.

Advancements in technology have brought about innovations in plumbing systems. Water conservation measures, such as the incorporation of low-flow fixtures, water-efficient appliances, and greywater recycling systems, are increasingly prevalent. Smart plumbing systems, equipped with features like leak detection sensors, remote shutoff valves, and water usage monitoring, enhance efficiency and maintenance capabilities. Moreover, a growing emphasis on sustainability has led to the integration of green plumbing practices, including rainwater harvesting, solar water heating, and the use of eco-friendly materials.

Safety remains paramount throughout the construction process, with strict adherence to safety protocols to prevent accidents and ensure the well-being of workers and occupants. Quality assurance measures, including regular inspections and quality checks, verify that installations meet industry standards and specifications. Plumbing professionals undergo continuing education to stay abreast of the latest technologies, codes, and best practices, ensuring that modern plumbing systems deliver reliable and safe water supply and drainage solutions for both commercial and residential buildings.

This novel method and device significantly diverges from traditional practices in several key aspects: precision in implementation; efficiency in construction; reduction in material waste; versatility and adaptability; and ease of integration with modern technology.

Traditional methods for plumbing system design often relies on approximations and manual measurements on-site, which can lead to inaccuracies and inconsistencies. Our invention utilizes a detailed coordinate system that maps every crucial point in the plumbing layout, directly translatable to the physical construction site. This ensures that every component installed exactly as planned, reducing the margin of error.

By providing a clear, coordinate-based roadmap for the installation process, the invention streamlines construction workflows. Contractors and builders can plan and execute their work more swiftly, as the guesswork and time-consuming adjustments typically required are significantly minimized. This leads to faster project completion times and reduced labor costs.

The precise planning enabled by our system allows for more accurate estimation and use of materials. Traditional methods, which may lead to overestimation and excess dues to planning inaccuracies, contrast sharply with our approach, which aims for sustainability by minimizing waste. This not only has environmental benefits but also reduces project costs.

Unlike previous solutions that might be rigid or specific to certain types of plumbing systems, this invention is adaptable to a wide range of construction projects. Whether its residential buildings, commercial structures or specialized facilities, the coordinate system can be tailored to meet specific needs, making it a versatile tool in the construction industry.

This invention and method are designed to be compatible with digital drafting and modeling tools, facilitating easy integration into modern construction processes. This compatibility with BIM (building information modeling) software and other construction management platforms ensures that this invention and method aligns with the industry's move towards digitization and smart construction methodologies.

### BRIEF SUMMARY OF THE INVENTION

The present invention relates to a coordinate-based plumbing installation system designed to improve the precision and efficiency of plumbing system installations. Traditional methods often rely on manual measurements and interpretations of blueprints, leading to potential errors and inefficiencies. This invention addresses these challenges by integrating digital drafting tools with spatial coordinate mapping.

The system includes a drafting module that generates digital blueprints of the plumbing layout. A coordinate mapping module assigns precise spatial coordinates to critical points within the layout, such as pipe junctions and fixture connections. These coordinates are integrated into the blueprint via an integration module, resulting in a coordinate-enhanced blueprint.

This enhanced blueprint is transmitted to field devices through a transmission interface, allowing on-site technicians to access it via an installation interface. This interface aids in accurate component placement by providing real-time coordinate data. Additional modules may include a CAD analysis module for interpreting design geometries, an annotation module for field adjustments, and an augmented reality interface that overlays the blueprint onto the physical construction environment.

By providing precise spatial data and integrating it seamlessly into the construction workflow, this system aims to reduce installation errors, minimize material waste, and enhance overall project efficiency.

### DESCRIPTION

This invention addresses inaccuracies in traditional plumbing construction, leading to material wastage and inefficiencies in construction timelines. This invention introduces a novel approach to drafting, planning, and executing plumbing systems for construction projects. It employs a meticulously developed coordinate system integrated with blue prints, allowing for precise real world application. This method facilitates a more efficient, accurate, and waste-minimizing process for builders and contractors.

At the core of this invention is a unique drafting technique that incorporates a detailed coordinate system into plumbing blueprints. This system assigns specific coordinates to key points within the plumbing layout, such as angle changes, branch beginnings, and points where pipes rise through the foundation. These coordinates are directly translatable to the physical space of the construction site, ensuring unparalleled precision in the installation process.

This invention is a construction methodology that works off of the origin point of a 3-dimensional grid. The methodology is enacted through the means of compiling coordinates through a drafting process. This drafting process could be accomplished by software that automates nearly every component of the drafting process. It will be the eventual development of true CAD blueprints that will make this methodology thrive. Artificial intelligence plays a role solely as a custodian or librarian of the system. It is not integral to the system. It is then, that the coordinates are then described in actual space by the means of a laser guidance system.

Advantages of the invention include but are not limited to: a) increased accuracy by reducing installation errors; b) cost efficiency through lower project costs by minimizing waste and optimizing labor; c) sustainability by reducing environmental impact through more precise material use; d) and versatility through adaptability to various construction needs beyond plumbing.

To implement this invention, builders and contractors begin by drafting the plumbing system using the specialized coordinate system. Each significant point in the system's design is mapped out on graph paper (or equivalent digital drafting tools) with the coordinates indicating its exact location in three-dimensional space.

Once the drafting phase is complete, the coordinates are used to guide the physical layout of the plumbing system on the construction site. Contractors can directly translate these coordinates to mark out, line, and plan the installation with minimal room for error, leading to a more streamlines and accurate construction process.

This method not only enhances accuracy of plumbing installations but also significantly reduces material waste. By precisely mapping out the system beforehand, excess materials are minimized, contributing to more sustainable construction practices.

While the invention is described primarily in the context of plumbing systems, its application can be extended to other aspects of construction where precision and efficiency are critical. For example, electrical wiring, HVAC systems, and structural framing could all benefit from this innovative approach to planning and implementation.

This detailed drafting process and coordinate system mark a significant advancement in construction technology. By enabling more precise and efficient project execution, this invention stands to revolutionize the industry, leading to faster construction times, reduced costs, and lower environmental impact.

The essential elements of this invention and method comprise: at least one or more drafting tools, an at least one or more coordinate system for blueprints, an at least one or more method for translating these coordinates to physical spaces, and an at least one or more system for calculating material needs and slopes.

Optional elements could include software for automating calculations and generating material lists, further improving efficiency and accuracy.

This invention a groundbreaking plumbing system design and coordination method is made practiced and implemented through a series of integrated steps that leverage both innovative drafting techniques and the practical application of a coordinate system to construction projects. This process ensures that plumbing systems are installed with unprecedented precision and efficiency.

The process comprises the development of a coordinate system and integration of that coordinate system with blueprints.

The first step involves creating a detailed coordinate system tailored to the plumbing layout of a construction project. This system assigns precise coordinates to every critical point within the plumbing design such as locations where pipes change direction where branches start and where pipes emerge through the foundation.

These coordinates are then meticulously integrated into the construction blueprints. The integration is performed in such a way that the blueprint not only shows the physical layout of the plumbing system but also includes the coordinate system that map these key points within the actual construction space.

The process is practiced by training and software integration and on-site implementation.

Contractors and builders are trained on how to read and interpret the enhanced blueprints that include the coordinate system. Additionally, the method is integrated into digital drafting tools and construction management software to facilitate seamless adoption and application in modern construction practices.

During the construction phase builders use the coordinate base blueprints to precisely mark out line plan and install the plumbing system. The coordinates guide the placement of plumbing components ensuring that each element is installed in its designated location as per the design specifications.

The process is implemented through the use of specialized equipment, quality control and adjustments, and documentation and feedback.

The implementation may involve the use of specialized equipment designed to translate the coordinates from blueprints to the physical construction site. This could include laser guided marking tools GPS based positioning equipment or augmented reality systems that overlay the coordinate system onto the actual construction environment.

As the plumbing system is installed, ongoing quality control checks are performed using the coordinate system to verify the accuracy of the installation. Any deviations from the plan can be quickly identified and corrected ensuring the system is installed correctly the first time.

Detailed documentation of the installation process is maintained including any adaptations or adjustments made to accommodate real world conditions, this feedback loop allows for continuous improvement of the drafting and coordination method refining the process for future projects. The invention revolutionizes the way plumbing systems are designed, planned and installed in construction projects. By bridging the gap between theoretical design and practical implementation and ensures higher accuracy, efficiency, and consistency across projects, setting a new standard in the construction industry.

This invention comprises a sophisticated method for designing and coordinating plumbing systems using a precise coordinate system integrated with construction blueprints. It is implemented as a step-by-step process that aligns theoretical planning with practical execution. This method is particularly beneficial for builders, contractors and engineers involved in the construction industry. The main steps of the process include but are not limited to a) pre-construction planning, which includes blueprint integration and material and resource planning; b) the construction phase, which includes site preparation, plumbing system installation, and quality assurance and adjustments; c) the post construction and maintenance phase which includes system validation and future maintenance and upgrades; and d) the user interaction portion which may include interactive tools and other applications.

The process begins in the planning phase where the unique coordinate system is integrated into the plumbing systems blueprints this integration allows for a detailed visualization of the systems layout within the context of the construction site providing a clear road map for installation.

With the detailed layout and coordinates in hand contractors can accurately estimate the materials and resources needed for the plumbing installation. This precise planning significantly reduces waste and ensures that resources are utilized efficiently.

Before installation begins, the construction site is prepared based on the coordinated blueprints. Using the provided coordinates contractors mark out the exact locations where plumbing components will be installed, ensuring that the layout matches the design specifications perfectly. Contractors follow the blueprint and coordinate system to install the plumbing components. The coordinates guide the placement of pipes fixtures and other elements ensuring each is located precisely as planned. This method facilitates A straightforward and error free installation process. Throughout the installation process the accuracy of the work is continually checked against the coordinated blueprints. If discrepancies are found adjustments are made to align with the planned layout ensuring the system functions as intended. Upon completion the plumbing system is thoroughly tested and validated to ensure it meets all performance and safety standards. The coordinate system aids in this process by providing A detailed reference for inspecting the installed components.

The detailed blueprints complete with the coordinate system serve as an invaluable resource for future maintenance and upgrades. Contractors can easily locate specific components within the system simplifying repairs and modifications.

To assist with the use of the invention, interactive tools and applications may be developed. These tools can help visualize the plumbing layout in three-dimensional view, overlay the coordinate system on digital models of the construction site, and provide virtual walkthroughs to aid in planning and installation. This invention can streamline the process of plumbing system installation from planning through to maintenance by ensuring precision reducing waste and saving time it represents a significant advancement in construction practices offering a method that is both efficient and environmentally responsible.

This invention introduces a revolutionary method for designing, planning, and executing plumbing installations within construction projects. Central to the invention is the integration of a precise coordinate system with construction blueprints creating a direct link between theoretical design and practical application. This system enhances accuracy efficiency and sustainability in construction practices particularly in plumbing installations.

The heart of the invention is a detailed coordinate system that assigns exact spatial locations to critical points in the plumbing layout. This includes junctions, bends, fixture connections and entry points through the foundation. The system is adaptable to both two-dimensional and three-dimensional blueprints allowing for versatility in design and application. The coordinate system is seamlessly integrated into plumbing blueprints providing a comprehensive visual and numerical guide for the installation process. These enhanced blueprints include not only the layout of the plumbing system but also precise instructions for locating each component within the physical space of the construction site.

By utilizing the coordinate system contractors can accurately position plumbing components according to the design specifications. This precision eliminates guesswork, reduces errors and ensures the plumbing system is installed correctly.

The drafting module is a digital system configured to receive plumbing layout data and generate construction blueprints. This module includes computer-aided design (CAD) tools and building information modeling (BIM) software used by engineers and drafters during the pre-construction phase. The drafting module enables the creation of a visual plumbing layout that is formatted for integration with a spatial coordinate system.

The coordinate mapping module assigns spatial coordinate data to key plumbing locations within the layout. These key locations include pipe junctions, directional changes, fixture connections, and foundation penetrations. The module translates the blueprint layout into a coordinate-based framework using a fixed origin point at the construction site, defining each critical location in three-dimensional space.

The integration module combines the assigned coordinate data with the plumbing blueprint to generate a coordinate-enhanced blueprint. This blueprint visually represents the plumbing system layout along with the specific coordinates for each system component. The integration module ensures that the coordinate data is embedded into the digital blueprint in a format suitable for downstream use during construction.

The transmission interface delivers the coordinate-enhanced blueprint to construction planning systems and field personnel. This interface transfers the enhanced blueprint to connected devices including tablets, project management software, or other networked systems used on-site. The transmission interface ensures all team members have access to the current version of the blueprint during installation.

The installation interface consists of a user-facing device configured to display the coordinate-enhanced blueprint at the construction site. The interface is used by contractors and technicians during installation to reference coordinates and place plumbing components in accordance with the design. The installation interface supports real-time interaction with the blueprint and may include capabilities for zooming, overlaying site visuals, or selecting blueprint layers.

The graphical interface enables users to interact with the coordinate-enhanced blueprint during drafting and installation. The interface allows for annotation, adjustment, and confirmation of coordinate data, and captures manual inputs made by engineers, supervisors, or installers. These user inputs are stored in association with the blueprint and used for documentation, revision control, and post-installation review.

The CAD analysis module interprets plumbing layout geometry and automatically derives spatial coordinate data. This module processes design drawings and assigns coordinate values to critical points such as junctions and endpoints. The CAD analysis module supports precision drafting by reducing manual effort and increasing layout accuracy prior to integration with the blueprint.

The annotation module enables users to edit, adjust, or annotate the coordinate-enhanced blueprint. Changes may include comments on field conditions, material substitutions, or real-time design changes. All annotations are linked to coordinate-specific points and saved in the system for reference during inspection, maintenance, or future revisions.

The material and cut list generator uses the coordinate data to calculate required materials and component dimensions. This generator produces a detailed list of plumbing components, including pipe lengths and connector types, based on the design layout. The output is used to procure materials, optimize cutting operations, and reduce waste.

The augmented reality interface overlays the coordinate-enhanced blueprint onto the physical construction environment. This interface uses AR-capable devices to project component positions onto walls, floors, or ceilings, enabling precise placement without manual measurement. The augmented reality interface provides visual guidance during installation and enhances the accuracy of component alignment.

The detailed planning enabled by this invention allows for a more accurate estimation of materials, minimizing waste and optimizing resource use. This efficiency not only reduces construction costs but also contributes to environmental sustainability.

While designed with plumbing installations in mind the coordinate systems methodology is applicable to other construction domains such as electrical, HVAC, and structural installation. This versatility makes the invention a valuable tool across the construction industry.

This system leverages advanced software and hardware to revolutionize plumbing infrastructure. At its core it combines software and artificial intelligence driven analysis with precise laser guided installations to enhance efficiency and accuracy in plumbing projects. This system integrates very well with existing construction processes, offering a scalable solution to reduce waste, lower costs, and improve the quality of installations. By simplifying complex concepts it's designed to be accessible to professionals across the industry ensuring that even those with minimal technical background can understand and apply its benefits effectively.

This invention aims to revolutionize residential construction through the development and implementation of a groundbreaking system that integrates advanced CAD software with precise AI-enhanced construction methodologies. By employing detailed blueprints, material lists, cut lists, and AI-generated assembly instructions alongside a novel use of laser guided positioning with a new grid system, this invention seeks to dramatically increase construction efficiency enhance build quality and minimize environmental impact.

During the planning phase, designers and engineers integrate the coordinate system into the project's blueprints. This phase involves mapping out the plumbing system and assigning coordinates to each component.

During the construction phase, contractors use blueprints to mark the exact locations of plumbing components on the construction site. Specialized tools, such as laser guides or GPS devices, may be used to translate the coordinates from paper to physical space.

Continuous quality control checks are performed during installation to ensure adherence to the blueprint specifications. Any deviations are corrected based on the coordinate system, ensuring the integrity of the final installation.

It is an object of the present invention to improve the accuracy of the construction and planning process.

It is an object of the present invention to reduce material waste.

It is an object of the present invention to enhance the sustainability of plumbing installations.

It is an object of the present invention to enhance the sustainability of building and ship construction.

It is an object of the present invention to simplify the installation process for plumbing systems through clear, coordinate-based visual guidance.

It is an object of the present invention to enable more efficient project scheduling by reducing installation time and rework caused by layout inaccuracies.

It is an object of the present invention to support real-time verification of plumbing component placement using digital tools linked to the blueprint coordinates.

It is an object of the present invention to integrate coordinate-based blueprint systems with existing construction management and BIM platforms.

It is an object of the present invention to enhance worker safety by reducing the need for manual measurement and field guesswork.

It is an object of the present invention to increase construction efficiency across various environments, including underground, marine, and high-rise structures.

It is an object of the present invention to reduce training time for new installers by providing intuitive, coordinate-driven guidance systems.

It is an object of the present invention to improve the traceability of field changes and deviations by linking annotations and manual inputs to specific blueprint coordinates.

It is an object of the present invention to facilitate code compliance and inspection workflows through precise digital documentation of installed components.

It is an object of the present invention to improve lifecycle maintenance of plumbing systems by preserving coordinate-enhanced blueprint records for future service events.

It is an object of the present invention to adapt to both two-dimensional and three-dimensional drafting environments with equal precision.

It is an object of the present invention to reduce costs associated with over-ordering or miscutting plumbing materials.

It is an object of the present invention to offer flexible deployment across diverse construction sectors including residential, commercial, medical, and marine.

It is an object of the present invention to provide a standardized method of communication between designers, contractors, and inspectors during construction projects.

It is an object of the present invention to support advanced visualization methods including augmented reality and projection-based marking systems for installation alignment.

Advantages of the present invention include but are not limited to increased planning and implementation precision, reduced environmental impact, and potential cost savings through efficient material use.

Although the invention has been described in detail with reference to several embodiments additional variations and modifications exist within the scope of the spirit of the invention as described.

In alternative embodiments, the coordinate system is adapted to operate with two-dimensional construction layouts where vertical alignment is not required. In these embodiments, the system assigns X and Y coordinate values relative to a fixed horizontal origin point. This configuration is suited for applications such as slab-on-grade residential buildings or modular unit assemblies where elevation control is built into the construction environment.

In some embodiments, the coordinate mapping module is configured to support multiple unit systems, including metric, imperial, or custom-scaled values. This allows the system to function across international construction standards and to be scaled appropriately based on the size and resolution required for the project.

In certain embodiments, the installation interface includes voice control functionality to enable hands-free operation during installation. This is particularly useful in environments where workers wear gloves or operate in limited-visibility conditions. Voice prompts can be used to retrieve coordinates, navigate blueprint sections, or confirm component placement.2 In another embodiment, the system is integrated directly into commercial construction management platforms to enable real-time data exchange between contractors, subcontractors, project managers, and inspectors. This integration ensures that updates to blueprints, installation progress, and material lists are synchronized across all users in the construction workflow.

The coordinate system may also be implemented in related disciplines, such as the installation of irrigation systems, medical gas delivery networks in healthcare facilities, or piping layouts in marine or shipbuilding contexts. These environments require similar accuracy and spatial control, and the system described herein is well-suited for such use cases.

The coordinate-enhanced blueprint may be accessed using a variety of hardware devices, including tablets, wall-mounted displays, wearable augmented reality glasses, or mobile projection systems. These variations allow the system to adapt to a range of jobsite environments, including indoor, outdoor, high-vibration, or low-light settings.

In field environments where satellite-based positioning is unavailable or unreliable, the system may utilize inertial measurement units (IMUs), local triangulation with fixed beacons, or optical recognition of marked reference points to establish and verify coordinate positions. This allows the system to operate effectively in tunnels, basements, or densely built urban settings.

In some configurations, the verification module includes the ability to log images or video clips of component installations, automatically linking each capture to its corresponding coordinate reference in the blueprint. These visual logs serve as a time-stamped, field-verified record for use in inspections, audits, and quality assurance processes.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

### DETAILED DESCRIPTION OF THE DRAWINGS

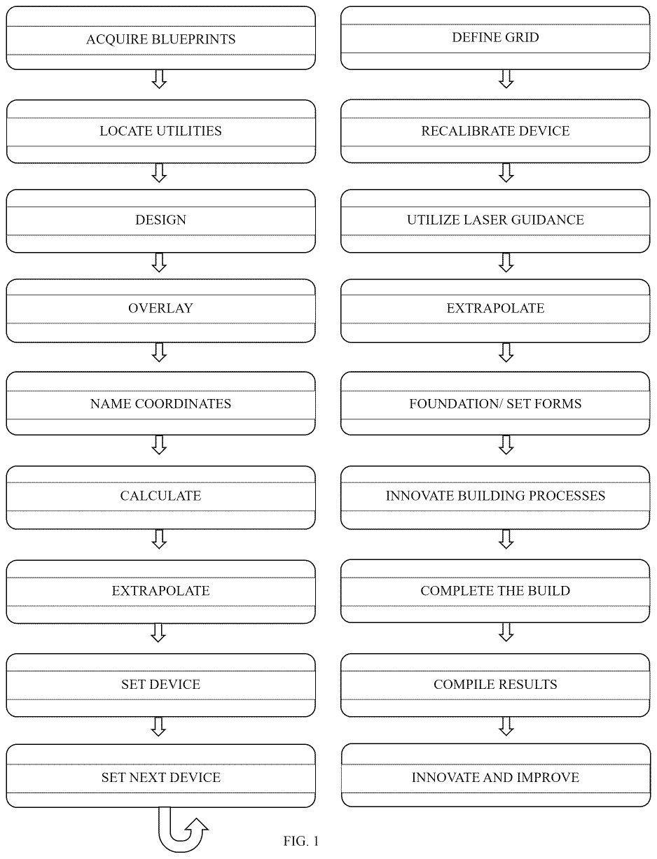

FIG. 1 is a flow chart illustrating a method for coordinating the layout and installation of a plumbing system using a coordinate-guided process. The method begins with blueprint acquisition and utility locating, followed by formwork and foundation preparation. A design overlay is created, and coordinate data is extrapolated and applied to the layout. Key steps include naming and organizing coordinate points, establishing a grid, setting and calibrating layout devices, and using laser-based tools to mark physical positions. The process continues through execution and innovation phases, including calculation, marking, and layout refinement. The method concludes with build completion, documentation of results, refinement of processes, and preparation for device relocation to the next project phase.

What is claimed is:

1. A method for coordinating the installation of an at least one or more plumbing system at an at least one or more construction site, comprising: receiving an at least one or more blueprint of said at least one or more plumbing system(s); generating said at least one or more coordinate system that defines an at least one or more three-dimensional spatial grid relative to an at least one or more fixed origin point at said at least one or more construction site; assigning an at least one or more coordinate data to key locations in an at least one or more plumbing layout within said at least one or more blueprint, said at least one or more key locations including at least one or more of: an at least one or more pipe junctions, an at least one or more directional changes, an at least one or more branch connections, an at least one or more fixture connections, or an at least one or more penetration points through an at least one or more foundation; integrating said at least one or more coordinate data into said at least one or more blueprint to produce an at least one or more coordinate-enhanced blueprint; transmitting said at least one or more coordinate-enhanced blueprint to an at least one or more digital drafting platform or an at least one or more construction planning interface; translating said at least one or more coordinate data into an at least one or more field-based physical positions on said at least one or more construction site using an at least one or more of: an at least one or more laser-guided marking system, an at least one or more GPS-enabled device, or an at least one or more augmented reality interface; marking or identifying an at least one or more physical locations on said at least one or more site for placement of said at least one or more plumbing components based on said at least one or more coordinate data; installing said at least one or more plumbing components at said at least one or more marked positions; verifying placement of an at least one or more installed plumbing components by cross-referencing their field-based positions with said at least one or more coordinate-enhanced blueprint and; documenting an at least one or more deviations or corrections, if any, and updating said at least one or more blueprint accordingly.

2. The method of claim 1, further comprising generating said at least one or more digital model of said at least one or more plumbing system integrated with said at least one or more Building Information Modeling (BIM) software.

3. The method of claim 1, wherein said at least one or more coordinate system includes said at least one or more elevation data for vertical alignment of said at least one or more plumbing components.

4. The method of claim 1, further comprising generating said at least one or more cut list or said at least one or more material estimate by correlating said at least one or more coordinate data with said at least one or more predefined component specifications, wherein said at least one or more cut list is linked to each corresponding said at least one or more coordinate-marked location in said at least one or more coordinate-enhanced blueprint.

5. The method of claim 1, wherein verifying placement of said at least one or more installed plumbing components further comprises applying an at least one or more quality assurance algorithm configured to compare measured said at least one or more field-based positions to said at least one or more assigned coordinate data, said comparison triggering said at least one or more alert if said at least one or more installed components exceed said at least one or more defined tolerance threshold.

6. The method of claim 1, wherein said at least one or more installation step is guided by an at least one or more user-operated handheld device, said at least one or more handheld device being configured to display said at least one or more coordinate-enhanced blueprint in real-time, and to provide an at least one or more visual or haptic feedback when said at least one or more correct placement location is achieved.

7. The method of claim 1, further comprising storing said at least one or more coordinate-enhanced blueprint, said at least one or more verification results, and said at least one or more documentation of said at least one or more deviations or corrections within an at least one or more searchable database, said at least one or more database being accessible by said at least one or more authorized user for said at least one or more future maintenance or system upgrade.

8. The method of claim 1, wherein said at least one or more receiving and transmitting steps are performed using said at least one or more cloud-based project management interface, said at least one or more interface being configured to provide said at least one or more synchronized access to said at least one or more coordinate-enhanced blueprint by said at least one or more authorized user across said at least one or more different phases of construction.

9. The method of claim 1, wherein said at least one or more coordinate data is automatically derived from said at least one or more blueprint by an at least one or more computer-aided design (CAD) analysis module, said at least one or more module being configured to detect and map said at least one or more geometry of said at least one or more plumbing layout into said at least one or more three-dimensional coordinate framework.

10. The method of claim 1, further comprising receiving said at least one or more manual user input through said at least one or more graphical interface to annotate, revise, or adjust said at least one or more coordinate-enhanced blueprint during said at least one or more installation, wherein said at least one or more graphical interface is configured to track and log said at least one or more manual change for said at least one or more audit purpose.

11. A system for coordinating an at least one or more installation of an at least one or more plumbing system at an at least one or more construction site, comprising: an at least one or more drafting module configured to receive an at least one or more plumbing layout data and to generate an at least one or more blueprint; an at least one or more coordinate mapping module configured to assign said at least one or more spatial coordinate to an at least one or more key plumbing location, said at least one or more key plumbing location including an at least one or more of: an at least one or more pipe junction, an at least one or more directional change, an at least one or more fixture placement, or an at least one or more foundation penetration; an at least one or more integration module configured to combine said at least one or more spatial coordinate with said at least one or more blueprint to produce said at least one or more coordinate-enhanced blueprint; an at least one or more transmission interface configured to deliver said at least one or more coordinate-enhanced blueprint to an at least one or more construction management system; an at least one or more positioning module comprising an at least one or more of: an at least one or more laser-guided marking system, said at least one or more GPS-enabled tool, or said at least one or more augmented reality interface, said at least one or more positioning module configured to translate said at least one or more coordinate data into an at least one or more physical marking at said at least one or more construction site; said at least one or more installation interface comprising an at least one or more user-facing device configured to display said at least one or more coordinate-enhanced blueprint and to receive an at least one or more user input during said at least one or more plumbing installation; an at least one or more verification module configured to validate said at least one or more installation accuracy by comparing an at least one or more field-based component placement to said at least one or more coordinate data; and an at least one or more documentation module configured to record an at least one or more deviation, an at least one or more update, or an at least one or more field change for said at least one or more post-installation use.

12. The system of claim 11, further comprising an at least one or more cloud-based platform configured to provide an at least one or more multi-user access to said at least one or more coordinate-enhanced blueprint during an at least one or more construction process.

13. The system of claim 11, wherein said at least one or more coordinate mapping module includes said at least one or more elevation data for said at least one or more vertical positioning of said at least one or more plumbing component.

14. The system of claim 11, wherein said at least one or more verification module includes said at least one or more quality assurance algorithm configured to detect said at least one or more deviation beyond said at least one or more threshold tolerance.

15. The system of claim 11, wherein said at least one or more drafting module is configured to interface with said at least one or more Building Information Modeling (BIM) tool.

16. The system of claim 11, wherein said at least one or more documentation module includes said at least one or more archive feature configured to store said at least one or more completed project data for said at least one or more future reference.

17. The system of claim 11, wherein said at least one or more integration module is further configured to generate said an at least one or more material list and said an at least one or more cut plan based on said at least one or more assigned coordinate.

18. The system of claim 11, wherein said at least one or more installation interface includes said at least one or more touchscreen tablet configured to display said at least one or more three-dimensional rendering of said at least one or more coordinate-enhanced blueprint.

19. The system of claim 11, wherein said at least one or more coordinate mapping module uses said at least one or more CAD analysis engine to automatically derive said at least one or more spatial data from said at least one or more digital plumbing layout.

20. The system of claim 11, further comprising said at least one or more annotation module configured to allow said at least one or more user to adjust said at least one or more coordinate data in response to said at least one or more real-time construction variable.
